(19) United States
(12) Patent Application Publication
(10) Pub. No.: US 2025/0153106 A1
(43) Pub. Date: May 15, 2025

(54) MOVABLE DEVICE FOR EXTRACTING LITHIUM SALTS FROM BRINE OF SALT LAKES

(71) Applicant: XI'AN LANSHEN NEW MATERIAL TECHNOLOGY CO., LTD., Xi'an (CN)

(72) Inventors: Dongbo SUN, Xi'an (CN); Xiaolong TAN, Xi'an (CN); Zhijun FENG, Xi'an (CN); Bingjie SUN, Xi'an (CN)

(21) Appl. No.: 18/947,880

(22) Filed: Nov. 14, 2024

(30) Foreign Application Priority Data
Nov. 15, 2023 (CN) 202323092295.3
Nov. 6, 2024 (CN) 202411579021.3

(51) Int. Cl. B01D 61/58; B01D 15/02; B01D 61/02; B01D 61/04; B01D 61/42; C01B 25/30; C01D 1/32; C01D 1/38; C01D 1/42; C01D 3/16; C01D 7/26; C01D 7/32; C01D 15/02; C01D 15/04; C01D 15/08; C22B 26/12

(52) U.S. Cl. CPC B01D 61/58; B01D 15/02; B01D 61/04; C01B 25/30; C01D 1/32; C01D 1/38; C01D 1/42; C01D 3/16; C01D 7/26; C01D 7/32; C01D 15/02; C01D 15/04; C01D 15/08; C22B 26/12; B01D 61/025; B01D 61/027; B01D 61/422; B01D 2311/04; B01D 2313/243; C01P 2006/80

(57) ABSTRACT

A movable device, e.g., a laboratory, for obtaining lithium salt from brine has a movable box, and a device for removing impurities from brine and a lithium precipitation device that are disposed in the movable box. The device for removing impurities from brine is connected to the lithium precipitation device. The device for removing impurities from brine comprises one or more of an adsorption-separation device, a membrane device, an electrodialysis device, a device for deeply removing impurities with resin, and an evaporation device. The laboratory is in a form of box modular assembly and may be placed on a truck and flexibly transported to a brine lake. In a case of a large-scale pilot test, an adsorption-membrane coupling technology to evaporation and lithium precipitation may be completely implemented, so that a simulation test of a whole lithium carbonate process may be carried out on site.

### CROSS-REFERENCE TO RELATED APPLICATIONS

The present application claims the priority rights of the following prior applications: the application filed before China National Intellectual Property Administration on Nov. 15, 2023, with the patent application No. 202323092295.3, titled “A Movable Device for Obtaining Lithium Salts from Brine of Salt Lakes”, and the application filed before China National Intellectual Property Administration on Nov. 6, 2024, with the patent application No. 202411579021.3, titled “A Movable Device for Obtaining Lithium Salts from Brine of Salt Lakes”. The aforementioned prior applications are incorporated herein by reference in their entirety.

### TECHNICAL FIELD

The present disclosure relates to the technical field of high-tech transformation of traditional industries, specifically to a movable experimental device for obtaining lithium salts such as lithium carbonate, lithium hydroxide, lithium phosphate, or lithium chloride from brine lakes, particularly a movable laboratory.

### BACKGROUND

With the advocacy of low-carbon and environmental protection policies, the continuous implementation of new energy policies, and the rapid development of the new energy industry, lithium battery technology has become one of the hottest topics of discussion today, and the market for lithium battery-related materials remains booming. As the technology for lithium extraction from brine lakes continues to break through and innovate, lithium extraction from salt lakes has become an important supply sector for lithium battery raw materials. The development of the industry's mainstream process, adsorption-membrane coupling technology, is becoming increasingly mature, which also promotes the continuous expansion of the industry's production capacity.

The process of extracting lithium salts from brine lakes to the entire production line of lithium salt products is massive and subject to natural and production conditions. In different brine lake mining areas, the development and experimental verification work of the entire process route of lithium salt production technology from brine lakes is difficult and inefficient. It is not possible to flexibly and effectively simulate continuous experimental operations from brine lake lithium to lithium salts on-site in a short time, which is time-consuming, operationally complex, and requires a lot of manpower, financial resources, and materials. Moreover, even if some experimental equipment is made into movable units, only some extraction process links can be operated in the brine lake mining area to obtain the intermediate product solution after extraction. However, the said intermediate product solution still needs to be transported to a fixed laboratory or workshop at a considerable distance to complete the synthesis and separation of the target lithium salts. More importantly, if the intermediate product solution is transported to a fixed laboratory or workshop at a considerable distance, higher requirements will be placed on the stability and cleanliness of the inner wall material of the container for transporting the intermediate product solution. It should be understood that if the inner wall material is prone to degradation, or if the container contains residues from previous experiments, it will inevitably affect the accuracy of the experimental results. In addition, such equipment still requires additional acids or bases required by the process. In areas where the transportation of acid and base is difficult, especially in areas lacking acid and base, such issues will seriously hinder the implementation of the experiment.

Therefore, there is a need for an efficient, easy-to-operate, simple, and unrestricted by the natural and production conditions of the experimental area, movable experimental device, especially a movable independent laboratory, so as to achieve “in-situ” simulation operations of the entire process route in brine lake mining areas and obtain more accurate experimental results.

### SUMMARY

The purpose of the present disclosure comprises providing a movable experimental device, particularly a movable laboratory, for obtaining lithium salts from brine of brine lakes. The device or laboratory can be transported by a truck to the site of the brine lake mining area for in-situ complete laboratory operations, thereby greatly shortening the experimental cycle, overcoming the limitations of laboratory operations, and solving the problems of difficult, inefficient, and/or limited accuracy of the development and experimental verification work of the entire process route of lithium salt production technology from brine lake brine, as well as the difficulties in transporting acid and base, especially in areas lacking acid and base.

The present disclosure is realized through the following technical solution:

A movable device for obtaining lithium salts from brine of brine lakes, comprising a movable box and a brine purification device and a lithium precipitation device set inside the movable box; wherein the brine purification device is connected to the lithium precipitation device; the brine purification device comprises one or more of an adsorption separation device, a membrane device, an electrodialysis device, a resin deep purification device, and an evaporation device.

Preferably, the adsorption separation device (71) contacts the lithium-containing solution with a lithium adsorbent (preferably an adsorbent produced under patent No. ZL 202011080243.2) filled in a rotating device, and adsorbs lithium from the lithium-containing raw material onto the adsorbent through the selectivity of the adsorbent for lithium.

Preferably, the size of the adsorption separation device (71) is determined based on the amount of adsorbent resin filled (i.e., the volume of the adsorbent) V_{ads}, where V_{ads} is calculated as follows: V_{ads}=Qₗᵢₜₕᵢᵤₘ/(η_{yield}*C_{adsorption}), wherein:
V_{ads}—Volume of adsorbent (L)
Qₗᵢₜₕᵢᵤₘ—Amount of lithium metal produced (g)
C_{adsorption}—Adsorption capacity of the adsorbent (g/L)
η_{yield}—Lithium yield;

Preferably, C_{adsorption} represents the adsorption capacity (g/L) of the adsorbent in patent No. ZL 202011080243.2.

Preferably, the volume V_{single} of a single adsorption column of the adsorption separation device (71) is calculated as: V_{single}=V_{ads}/(η_{coefficient}*n), wherein:
V_{single}—Volume of resin filled per column (L)
V_{ads}—Volume of adsorbent (L)
η_{coefficient}—Resin filling coefficient
n—Number of resin columns

Preferably, the height H of a single adsorption column of the adsorption separation device (71) is calculated as: H=V_{single}/S, wherein:
H—Height of the adsorption column (mm)
S—Cross-sectional area of the adsorption column (mm²)

Preferably, the height of the adsorption separation device (71) can be determined based on the height H of the adsorption column. Moreover, the adsorption separation device (71) should comprise the height of the frame and the supporting machine base.

According to the implementation of the present disclosure, the adsorbent is a lithium adsorbent.

According to the embodiment of the present disclosure, the movable device is preferably a movable laboratory. More preferably, the movable laboratory enables those skilled in the art to perform complete laboratory operations, especially complete “in-situ” experimental operations, within the space of the laboratory according to the conditions required at the brine lake mining site.

Preferably, the brine purification device comprises an adsorption separation device, a membrane device, an electrodialysis device, a resin deep purification device, and an evaporation device connected in sequence; and the evaporation device is connected to the lithium precipitation device.

Furthermore, several movable boxes are provided, among which a movable box is equipped with one or more of an adsorption separation device, a membrane device, an electrodialysis device, a resin deep purification device, an evaporation device, and a lithium precipitation device.

Additionally, the adsorption separation device, membrane device, electrodialysis device, resin deep purification device, evaporation device, and lithium precipitation device are connected in sequence using quick connectors.

Preferably, the movable experimental device comprises an acid-base preparation device set inside the movable box; and/or, the movable experimental device comprises a pure water preparation device set inside the movable box.

Preferably, the movable box has base frames fixedly installed on both sides; and the brine purification device and lithium precipitation device are set on the base frames.

Preferably, the movable box is equipped with an exhaust facility, and/or, the movable box has a lighting facility installed inside.

Preferably, the membrane device comprises an ultrafiltration device and a nanofiltration device connected in sequence.

Preferably, the ultrafiltration device comprises a first membrane rack and an RO membrane feed pump, a first membrane tube, and an RO membrane product tank connected in sequence set on the first membrane rack; and/or, the nanofiltration device comprises a second membrane rack and an NF membrane feed pump, a second membrane tube, and an NF membrane product tank connected in sequence set on the second membrane rack.

Preferably, the electrodialysis device comprises a first rack and an electrodialysis feed pump, a first membrane stack, and an electrodialysis product tank connected in sequence set on the first rack; and/or,
the resin deep purification device comprises a second rack and a resin purification feed pump, a resin column, and a resin product tank connected in sequence set on the second rack; and/or,
the lithium precipitation device comprises a lithium precipitation feed pump, a lithium precipitation reactor, a thickener, a solid-liquid separation unit, a washing unit, and a drying unit connected in sequence; a stirring unit is set inside the lithium precipitation reactor.

Compared to prior art, the present disclosure has the following advantages:

The movable device and movable laboratory of the present disclosure integrate experimental equipment in the form of modular assembly inside the boxes, which can be independently placed on trucks and other means of transportation, flexibly transported to the brine lake area with harsh natural and production conditions for direct in-situ simulation experiments. On a large pilot experimental scale, it can fully realize from adsorption-membrane coupling technology to evaporation and lithium precipitation, ultimately achieving the simulation experiment of the entire lithium salt process that can be carried out in a non-laboratory site. The present disclosure could solve the problem of the existing lithium salt production process route being difficult to simulate experiments flexibly on-site in the brine lake area, solves the problems of low efficiency, high difficulty, complex operation, and/or low accuracy in the development research of the lithium salt production process route, greatly shortens the experimental cycle, avoids the limitation of needing to transport intermediate solutions to fixed laboratories or workshops at a considerable distance, and avoids the limitation of needing to provide additional acids or bases for experiments in areas with difficult acid-base transportation, especially in areas lacking acid and base, achieving effective in-situ experiments in a non-laboratory site, thereby verifying the feasibility and precision of the lithium salt production process line, greatly improving the operability and efficiency of the lithium salt entire process route development, and greatly reducing labor costs, time costs, and current segmented experimental energy consumption.

Furthermore, the assembly and combination method of the movable device and movable laboratory of the present disclosure are flexible, and each device can be combined in different boxes according to the actual situation, connected by quick connectors, to achieve the requirements of rapid connection and disassembly of the entire simulation process route. It should be understood that although the movable device and movable laboratory of the present disclosure allow for adjustment and disassembly after being transported to the brine lake mining area, compared with traditional methods or partial modular forms, since the movable device or movable laboratory of the present disclosure has already integrated and connected the equipment units inside the boxes, the number of engineering and electromechanical technicians required and the amount of equipment assembly work after being transported to the brine lake mining area will be greatly reduced.

Furthermore, the movable device and movable laboratory of the present disclosure also set up a pure water preparation device and/or an acid-base preparation device, which can solve the problem of acid-base scarcity in the brine lake area, further improving the overall efficiency.

Furthermore, the movable device and movable laboratory of the present disclosure have base frames fixedly installed on both sides inside the movable box; the brine purification device and lithium precipitation device are set on the base frames, which facilitates disassembly and assembly.

Furthermore, the movable device and movable laboratory of the present disclosure are equipped with an exhaust facility for air exchange between the interior space of the movable box and the outside, so as to maintain a constant temperature and ensure the safety of operating personnel. A lighting facility are installed for illumination, so as to meet 24-hour operation requirements and improve experimental efficiency.

### FIGURE DESCRIPTION

FIG. 1 is a schematic diagram of the overall experimental device structure in a specific embodiment provided by the present disclosure;

FIG. 2 is a flowchart of the lithium salt experiment process provided by the present disclosure;

FIG. 3 is a block diagram of the overall experimental device in a specific embodiment provided by the present disclosure;

FIG. 4 is a structural schematic diagram of the adsorption separation device provided by the present disclosure;

FIG. 5 is a structural schematic diagram of the membrane device provided by the present disclosure;

FIG. 6 is a structural schematic diagram of the nanofiltration device provided by the present disclosure;

FIG. 7 is a structural schematic diagram of the electrodialysis device provided by the present disclosure;

FIG. 8 is a structural schematic diagram of the resin deep purification device provided by the present disclosure;

FIG. 9 is a structural schematic diagram of the evaporation device provided by the present disclosure;

FIG. 10 is a structural schematic diagram of the lithium precipitation device provided by the present disclosure.

FIG. 11 is a structural schematic diagram of the pure water preparation device provided by the present disclosure.

FIG. 12 is a structural schematic diagram of the acid-base preparation device provided by the present disclosure.

### DETAILED DESCRIPTION

To further understand the present disclosure, the disclosure will be further described in detail with reference to the following specific examples, which are merely to further explain the features and advantages of the disclosure and are not intended to limit the scope of the claims of the disclosure.

It should be noted that where a component is said to be “connected” to another component, it may be directly connected to the other component or there may be intermediate components present. Unless otherwise defined, all technical and scientific terms used herein are to be understood in the same sense as would be understood by those skilled in the art to which the disclosure pertains. It should also be noted that unless otherwise specifically defined and limited, the terms “mounted,” “connected,” and “coupled” are to be broadly understood, for example, they can be fixed connections or detachable connections, or integral connections; they can be mechanical connections or electrical connections, and can be internal connections between two elements.

Furthermore, in the description of the present disclosure, terms such as “center,” “up,” “down,” “left,” “right,” “vertical,” “horizontal,” “inner,” “outer,” and other directional or positional relationships indicated are based on the orientations or positional relationships shown in the accompanying drawings, and are solely for the purpose of describing the disclosure and simplifying the description, rather than indicating or implying that the devices or components referred to must have specific orientations, be constructed and operated in specific orientations, and thus should not be construed as limiting the disclosure. Additionally, the terms “first,” “second,” and “third” are used for descriptive purposes only and should not be understood as indicating or implying relative importance.

### Example 1: Movable Laboratory for Extracting Lithium Salts from Brine of Brine Lakes

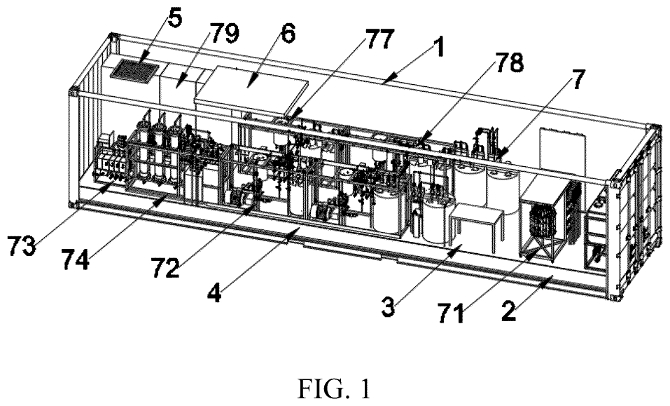

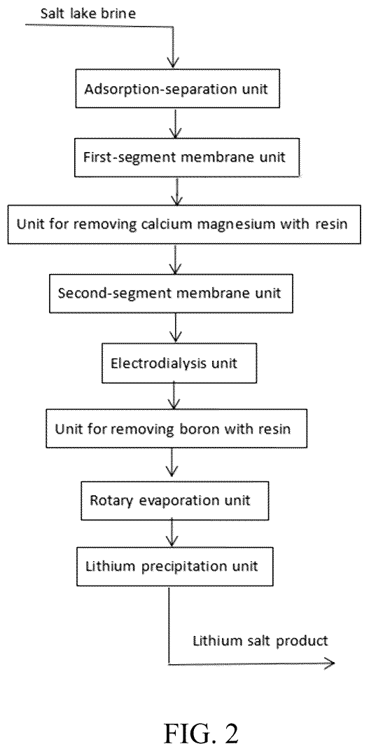

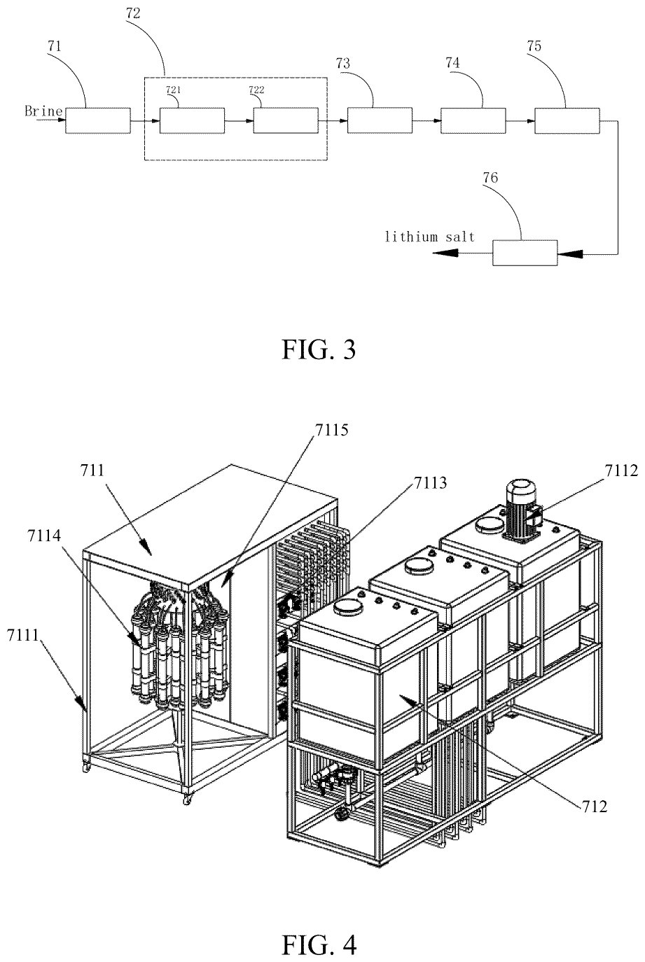

Refer to FIGS. 1 and 3, this example provides a movable device for extracting lithium salts from brine of brine lakes, comprising: a movable box 1 and a brine purification device and a lithium precipitation device 76 set inside the movable box 1, wherein said brine purification device is connected to the lithium precipitation device 76; said brine purification device comprises one or more of an adsorption separation device 71, a membrane device 72, an electrodialysis device 73, a resin deep purification device 74, and an evaporation device 75.

In this example, the movable experimental device comprises: a movable box 1, and sequentially connected adsorption separation device 71, membrane device 72, electrodialysis device 73, resin deep purification device 74, evaporation device 75, and lithium precipitation device 76; said adsorption separation device 71, membrane device 72, electrodialysis device 73, resin deep purification device 74, evaporation device 75, and lithium precipitation device 76 are all set inside the movable box. The movable box is preferably set with several, said adsorption separation device 71, membrane device 72, electrodialysis device 73, resin deep purification device 74, evaporation device 75, and lithium precipitation device 76 can be combined according to actual conditions and set in different movable boxes 1. The devices are connected with a pipeline selected from hose, stainless steel pipe, PVC, and the like.

The movable experimental device described in this example may also optionally comprise: an acid-base preparation device 78 and a pure water preparation device 77, which are also set inside the movable box 1. The base produced by the acid-base preparation device 78 is sodium hydroxide or lithium hydroxide.

The movable box 1 can be made of a material selected from carbon steel plate, stainless steel plate, channel steel, and angle steel, and the like; or it can be selected from a finished movable box, such as container, for example a freight container. The thickness of the material used for each face of the movable box 1 is preferably 0.5-5 mm, more preferably 1.5 mm; the channel steel used for the frame of the movable box 1 is preferably 5-12 #, more preferably 10 #channel steel. The length of the movable box 1 is 0-30 m, preferably 5-18 m, more preferably 12 m; the width of the movable box is 0-5 m, preferably 1-3 m, more preferably 2.55 m; the height of the movable box is 0-5 m, preferably 1-3 m, and more preferably 2.44 m.

The movable box 1 has base frames 2 fixedly installed on both sides; the base frames 2 are made of carbon steel, stainless steel, or heavy-duty steel materials that can withstand weight. It is preferred to make the base frames 2 with carbon steel and stainless steel materials, and further preferred to make them with stainless steel profiles. The base frames 2 are made of stainless steel square tubes with a thickness of 1-5 mm, preferably 3 mm. The base frames 2 leave a bottom space 4 of 1-80 cm high from the bottom of the movable box 1, preferably 2-30 cm, and more preferably 15 cm. The bottom space 4 is the space reserved by the base frames 2, which is used for laying cables and channels for connections between various units.

The base frames 2 are fixed on the bottom surface of the movable box 1, and the connection methods are welding, riveting, and bolting, with welding being preferred. The function of the base frames 2 is to support and fix the above-mentioned devices such as adsorption separation device 71, membrane device 72, electrodialysis device 73, resin deep purification device 74, evaporation device 75, lithium precipitation device 76, pure water preparation device 77, acid-base preparation device 78, and control system 79, facilitating overall movement and transportation.

The base frames 2 on both sides are connected by steel plates 3 to block the gaps between the devices, forming a safe fire passage. The steel plates 3 are made of carbon steel, stainless steel, or galvanized steel plates. It is preferred to make the steel plates 3 with carbon steel and stainless steel materials, and further preferred to make them with stainless steel plates. The steel plates 3 are made of steel plates with a thickness of 1-4 mm, preferably 3 mm stainless steel pipes. The function of the steel plates 3 is to lay on the base frames 2, serving as passages or fire passages.

The movable box 1 is equipped with an exhaust facility 5, which can be an axial flow fan, air conditioning, or exhaust fan, preferably air conditioning and exhaust fans, and more preferably exhaust fans. The function of the exhaust facility 5 is to facilitate air circulation between the interior space of the movable box 1 and the outside, maintaining a constant temperature, protecting electrical equipment, and ensuring the safety of operating personnel.

The movable box 1 is equipped with a lighting facility 6, which can be LED, incandescent lamp, or searchlight, installed on the ceiling facilities at the top of the movable box 1, preferably LED lamp and incandescent lamp, and more preferably LED lamp. The function of the lighting facility 6 is to provide illumination for 24-hour operation.

The adsorption separation device 71, membrane device 72, electrodialysis device 73, resin deep purification device 74, evaporation device 75, lithium precipitation device 76, pure water preparation device 77, and their control system 79 constitute the main process equipment 7 of the disclosure.

Refer to FIG. 4, the adsorption separation device 71 comprises a main unit 711 and a qualified liquid tank 712. The main unit 711 comprises a frame 7111, a first drive component 7112, a feed pump 7113, a rotating component 7114, and a control component 7115.

The size of the adsorption separation device (71) is determined based on the resin filling volume (i.e., the volume of the adsorbent) V_{ads}, which is calculated as follows: V_{ads}=Qₗᵢₜₕᵢᵤₘ/(η_{yield}*C_{adsorption}), wherein:
V_{ads}: Volume of adsorbent (L)
Qₗᵢₜₕᵢᵤₘ: Amount of lithium metal produced (g)
C_{adsorption}: Adsorption capacity of the adsorbent (g/L)
η_{yield}: Lithium yield

Preferably, C_{adsorption} represents the adsorption capacity (g/L) of the adsorbent as described in patent No. ZL 202011080243.2.

For illustrative purposes, the calculation process for the adsorption separation device (71) is as follows:

When the adsorption separation device (71) is required to produce 30 g of lithium metal, V_{ads}=30/(0.9*1.8)=18.51 L, wherein:
η_{yield} is the lithium yield, taken as 90%;
C_{adsorption} is the adsorption capacity (g/L) of the adsorbent described in patent No. ZL 202011080243.2, taken as 1.8 g/L;

The volume V_{single} of a single adsorption column in the adsorption separation device (71) is calculated as: V_{single}=V_{ads}/(η_{coefficient}*n), wherein:
V_{single}: Volume of resin filling per column (L)
V_{ads}: Volume of adsorbent (L)
η_{coefficient}: Resin filling coefficient
n: Number of resin columns

For example, the calculation process for the volume of a single resin column (L) is: V_{single}=18.51/0.8/30=0.77 L, wherein:
η_{coefficient} as the filling coefficient is taken as 80%;
n, the number of resin columns, is taken as 30 columns;

The height H of a single adsorption column in the adsorption separation device (71) is calculated as: H=V_{single}/S, wherein:
H: Height of the adsorption column (mm)
S: Cross-sectional area of the adsorption column (mm²)

For example, the calculation process for the height of a single resin column in the adsorption separation device (71) is: H=0.77*1000*1000/1384.74=557 mm, wherein:
S (cross-sectional area of the adsorption column, mm²) is taken as a value for an adsorption column with a diameter of 42 mm, with a calculated area of 1384.74 mm².

The height of the adsorption separation device (71) can be determined based on the height H of the adsorption column. Additionally, the adsorption separation device (71) should comprise the height of the frame and the support machine base.

For example, the frame height of the adsorption separation device is taken as 500 mm.

For example, the base of the adsorption separation device is taken as 500 mm.

For example, the total height H of the separation device is: 1557 mm.

In this example, the frame 7111 is made of carbon steel, stainless steel, or other structural steel materials capable of bearing weight, with a preference for carbon steel and stainless steel materials, and further preference for stainless steel profiles. The frame 7111 is made of square stainless steel tubes with dimensions of 1 cm-16 cm in length and width and a thickness of 1-5 mm, preferably square stainless steel tubes with dimensions of 5 cm in length and width and a thickness of 3 mm. The height of the frame 7111 is 1.2-2.5 m, the length is 1-2 m, and the width is 1-1.5 m; the preferred height is 1.8 m, the length is 1.5 m, and the width is 0.75 m.

In this example, the first drive component 7112 can be a servo motor, DC motor, or AC motor, with a preference for a servo motor. The pump 7113 can be a metering pump or peristaltic pump, with a preference for a peristaltic pump. The rotating component 7114 is constructed using one or a combination of materials such as PVC, UPVC, polytetrafluoroethylene (PTFE), or PVDF, preferably a combination of UPVC and PTFE. The control component 7115 consists of electrical and control elements.

In this example, the function of the frame 7111 is to secure the first drive component 7112, feed pump 7113, rotating component 7114, and control component 7115. The first drive component 7112 converts electrical energy into mechanical energy, driving the rotating component 7114 to rotate according to a certain pattern, achieving the lithium adsorption, washing, and elution processes. The feed pump 7113's function is to input raw brine into the rotating component 7114. The rotating component 7114's function is to hold selective lithium adsorbent materials and combine them in a certain pattern, under the drive of the drive component, to achieve the adsorption, washing, and regeneration processes of lithium from the raw material, utilizing the selectivity of the lithium adsorption material to separate lithium from other impurities in the raw material. The control component 7115's function is to control the operation of the drive component according to set requirements through electrical components; this part could use existing technology and is not discussed herein in detail.

In this example, the qualified liquid tank 712 is made of PE, PVC, fiberglass, and steel materials, with a preference for PE, PVC, and fiberglass materials, and more preferably PE material. The qualified liquid tank 712 is designed with 1-8 tanks, further preferred with 2-6 tanks, and further preferred with 3 tanks. The qualified liquid tank 712 is designed with a diameter of 0-1.5 m, further preferred with 0.1-0.8 m, and further preferred with 0.58 m. The qualified liquid tank 712 is equipped with heating devices, stirring devices, and liquid level monitoring devices. The function of the qualified liquid tank 712 is to store qualified liquid.

In this example, the main function of the adsorption separation device 71 is to contact the lithium-containing solution with the lithium adsorbent (preferably the adsorbent produced under patent number: ZL 202011080243.2) filled in the rotating device, adsorb lithium from the lithium-containing raw material onto the adsorbent through the selectivity of the adsorbent, and then obtain a lithium-containing qualified liquid with less impurities through elution, which is then sent to the membrane device 72 for further processing via pipelines or conveying equipment.

In this example, the adsorbent filling volume of the adsorption separation device 71 is 0-5000 L, preferably 5-50 L, and further preferred with 9-12 L; the operation steps are divided into three steps: adsorption, washing, and elution, suitable for brines with different lithium characteristics, where Li content is 30-8000 ppm, boron content is 0.01-7000 ppm, potassium content is 0.01-30000 ppm, magnesium content is 0.01-120000 ppm, calcium content is 0.01-40000 ppm, sodium content is 0.01-150000 ppm, and sulfate content is 0.01-65000 ppm, the adsorption flow rate is controlled at 0-7 BV, preferably 4 BV; the washing flow rate is controlled at 1-10 BV, preferably 8 BV, and the elution flow rate is controlled at 0-6 BV, preferably 5 BV.

The product liquid (desorbed liquid) obtained from the adsorption separation device 71 has the following compositions: lithium content of 80-1500 ppm, potassium 5-150 ppm, sodium content 0.01-800 ppm, calcium content 0.01-300 ppm, magnesium content 0.01-2300 ppm, boron content 0.01-1400 ppm, and sulfate content of 0.01-150 ppm.

The operating temperature of the adsorption separation device 71 is 0-60° C.

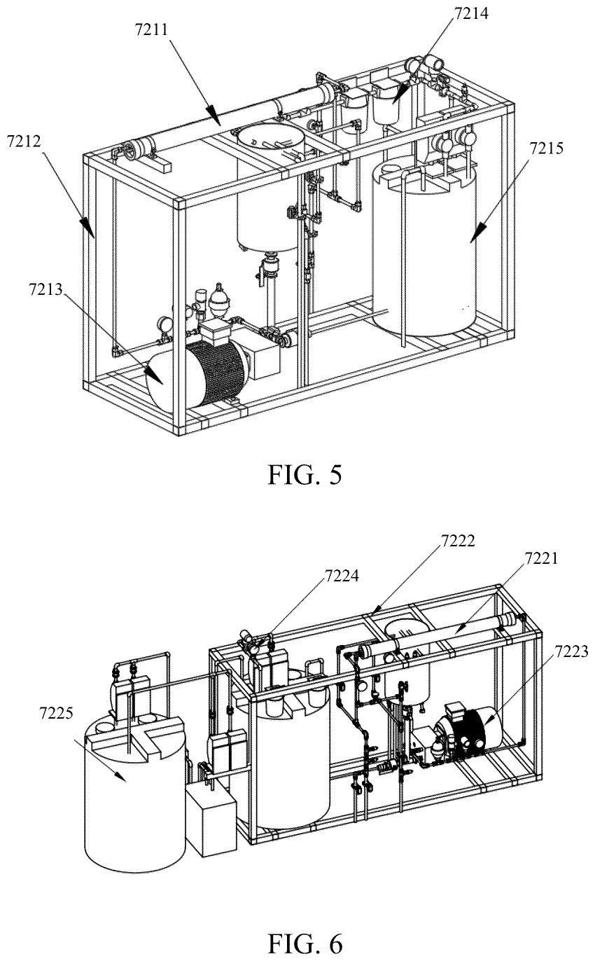

Refer to FIGS. 3 and 5, the membrane device 72 consists of a reverse osmosis device 721 and a nanofiltration device 722. The reverse osmosis device 721 comprises a first membrane rack 7212 and sequentially connected on the first membrane rack 7212: an RO membrane feed pump 7213, a first membrane tube 7211, and an RO membrane product tank 7215, as well as a first control valve 7214.

In this example, the size of the reverse osmosis device 721 and nanofiltration device 722 is determined based on the flow rate produced by the adsorption separation device (71), wherein:
S_{membrane}=Q_{feed}/q_{flux}
S_{membrane}—Membrane area (m²)
   Q_{feed-}—Feed flow rate (m³/h)
q_{flux-}—Membrane flux per unit time (m³/m²)

The size of the reverse osmosis device 721 and nanofiltration device 722 is determined based on the membrane area to specify the membrane dimensions.

The size of the reverse osmosis device 721 and nanofiltration device 722 is determined based on the feed flow rate to specify the pump size.

The size of the reverse osmosis device 721 and nanofiltration device 722 is determined based on the above dimensions to specify the frame and base dimensions.

For example, the flow rate of the desorbed liquid produced by the adsorption device is 76.92 L, and the membrane flux is 20 L/m² per unit time.

The calculation process for the membrane area S_{membrane} of the reverse osmosis device 721 and nanofiltration device 722 is: S_{membrane}=Q_{feed}/q_{flux}=46.15/20=2.31 m²;

Based on the membrane area, a 25/40 membrane can be selected.

The shell size of the 25/40 membrane is 1123 mm.

The membrane rack is selected to be 1.5 m long.

The first membrane tube 7211 is made of fiberglass, stainless steel, or ceramic, preferably fiberglass and stainless steel, and more preferably fiberglass. The function of the first membrane tube 7211 is to fill the membrane and separate salts from water in the qualified liquid. The manufacturing dimensions of the first membrane tube 7211 are 1 cm-30 cm in diameter, further preferred 5 cm-20 cm, and further preferred 10 cm.

The first membrane rack 7212 is made of square tube materials such as carbon steel, stainless steel, or other materials capable of bearing weight. It is preferred to make the first membrane rack 7212 with carbon steel and stainless steel square tube materials, preferably stainless steel square tube materials. The first membrane rack 7212 is made of stainless steel square tubes with specifications of 0-10 cm, further selected 2-8 cm square tube materials, and further selected 5 cm square tube materials. The manufacturing specifications of the first membrane rack 7212 are length: 0-3 m; width: 0-1.5 m; height: 0-5 m; further manufacturing specifications are length: 1-2.5 m; width: 0.7-1.2 m; height: 1-2.5 m; and further manufacturing specifications are length: 2 m; width: 1 m; height: 1.3 m.

The main function of the first membrane rack 7212 is to support the first membrane tube 7211, RO membrane feed pump 7213, first control valve 7214, and RO membrane product tank 7215, and is fixed on the base frame 2 at the bottom of the movable box 1.

The RO membrane feed pump 7213 can be a centrifugal pump, plunger pump, or diaphragm pump, preferably centrifugal pumps and diaphragm pumps, and more preferably centrifugal pumps.

The RO membrane feed pump 7213 is made of materials such as carbon steel, duplex stainless steel, or non-metals, preferably duplex stainless steel and non-metals, and more preferably duplex stainless steel. The function of the RO membrane feed pump 7213 is mainly for the transportation and pressure increase of qualified liquid.

The first control valve 7214 is made of materials such as carbon steel, duplex stainless steel, UPVC, CPVC, or PVC, preferably duplex stainless steel, UPVC, CPVC, or PVC, and more preferably PVC. The function of the first control valve 7214 is to control the opening and closing of the control valve through the control system, thereby achieving the on-off and flow direction of the material.

The RO membrane product tank 7215 is made of materials such as PE, PVC, fiberglass, and steel. It is preferred to make it with PE, PVC, and fiberglass materials, preferably PE material. The RO membrane product tank 7215 is designed with 1-5 tanks, further preferred with 1-3 tanks, and further preferred with 2 tanks. The RO membrane product tank 7215 is designed with a diameter of 0-1.5 m, further preferred with 0.1-0.8 m, and further preferred with 0.6 m. The function of the RO membrane product tank 7215 is to store the brine after reverse osmosis treatment.

The function of the reverse osmosis device 721 is to use a special membrane to transport the qualified liquid to the membrane through the RO membrane feed pump 7213 and the first control valve 7214, achieving the separation of salt and water, with the desalinated water stored in the freshwater tank, and the high-salt water stored in the RO membrane product tank 7215 for further treatment.

The feed components of the reverse osmosis device 721 are: lithium content of 80-1500 ppm, potassium content of 5-150 ppm, sodium content of 0.01-800 ppm, calcium content of 0.01-300 ppm, magnesium content of 0.01-2300 ppm, boron content of 0.01-1400 ppm, and sulfate content of 0.01-150 ppm; the feed flow rate is 0.01-2000 L/h. The desalinated water (product water) quantity is 0.01-1000 L/h, with components of: lithium content of 0.01-30 ppm, potassium content of 5-10 ppm, sodium content of 0.01-30 ppm, and boron content of 0.01-300 ppm. The brine quantity is 0.01-1000 L/h, with components of: lithium content of 800-2000 ppm, potassium content of 20-600 ppm, sodium content of 0.05-3200 ppm, boron content of 0.01-300 ppm, calcium content of 0.05-1000 ppm, and magnesium content of 0.01-3500 ppm.

Refer to FIG. 6, the nanofiltration device 722 comprises a second membrane rack 7222 and sequentially connected on the second membrane rack 7222: an NF membrane feed pump 7223, a second membrane tube 7221, and an NF membrane product tank 7225, as well as a second control valve 7224.

The second membrane tube 7221 is made of materials such as fiberglass, stainless steel, or ceramic, preferably fiberglass and stainless steel, and more preferably fiberglass. The function of the second membrane tube 7221 is to fill the membrane and remove calcium, magnesium, and sulfate ions from the brine produced by the reverse osmosis device 721. The manufacturing dimensions of the second membrane tube 7221 are 1 cm-30 cm in diameter, further preferred 5 cm-20 cm, and further preferred 10 cm.

The second membrane rack 7222 is made of materials such as carbon steel, stainless steel, or other square tube materials capable of bearing weight. It is preferred to make the second membrane rack 7222 with carbon steel and stainless steel square tube materials, preferably stainless steel square tube materials. The second membrane rack 7222 is made of stainless steel square tubes with specifications of 0-10 cm, further selected 2-8 cm square tube materials, and further selected 5 cm square tube materials. The manufacturing specifications of the second membrane rack 7222 are length: 0-3 m; width: 0-1.5 m; height: 0-5 m; further manufacturing specifications are length: 1-2.5 m; width: 0.7-1.2 m; height: 1-2.5 m; and further manufacturing specifications are length: 2 m; width: 1 m; height: 1.3 m. The main function of the second membrane rack 7222 is to support the second membrane tube 7221, the second membrane rack 7222, the NF membrane feed pump 7223, the second control valve 7224, and the NF membrane product tank 7225, etc., and is fixed on the base frame 2 at the bottom of the movable box 1.

The NF membrane feed pump 7223 can be a centrifugal pump, plunger pump, or diaphragm pump, preferably centrifugal pumps and diaphragm pumps, and more preferably centrifugal pumps. The NF membrane feed pump 7223 is made of materials such as carbon steel, duplex stainless steel, or non-metals, preferably duplex stainless steel and non-metals, and more preferably duplex stainless steel. The function of the NF membrane feed pump 7223 is mainly to pump the liquid from the RO membrane product tank 7215 into the nanofiltration device 722.

The second control valve 7224 is made of materials such as carbon steel, duplex stainless steel, UPVC, CPVC, or PVC, preferably duplex stainless steel, UPVC, CPVC, or PVC, and more preferably PVC. The function of the second control valve 7224 is to control the opening and closing of the control valve through the control system, thereby achieving the on-off and flow direction of the material.

The NF membrane product tank 7225 is made of materials such as PE, PVC, fiberglass, and steel. It is preferred to make it with PE, PVC, and fiberglass materials, preferably PE material. The NF membrane product tank 7225 is designed with 1-5 tanks, further preferred with 1-3 tanks, and further preferred with 2 tanks. The NF membrane product tank 7225 is designed with a diameter of 0-1.5 m, further preferred with 0.1-0.8 m, and further preferred with 0.6 m. The function of the NF membrane product tank 7225 is to store the nanofiltration desalinated water.

The function of the nanofiltration device 722 is to use a special membrane to transport the liquid from the RO membrane product tank 7215 to the membrane through the NF membrane feed pump 7223 and the second control valve 7224, achieving the separation of monovalent ions from divalent ions (calcium, magnesium, and sulfate), with the desalinated water stored in the NF membrane product tank for further treatment, and the concentrated brine containing calcium and magnesium stored in the concentrated brine tank, transported to the adsorption separation device for adsorption and recovery of lithium.

The feed brine quantity of the nanofiltration device 722 is 0.01-1000 L/h, with components of: lithium content of 800-2000 ppm, potassium content of 20-600 ppm, sodium content of 0.05-3200 ppm, boron content of 0.01-300 ppm, calcium content of 0.05-1000 ppm, and magnesium content of 0.01-3500 ppm.

The product water flow rate (desalinated water) of the nanofiltration device 722 is 0.01-1000 L, with components of: lithium content of 800-2000 ppm, potassium content of 20-600 ppm, sodium content of 0.05-3800 ppm, boron content of 0.01-300 ppm, calcium content of 0.05-20 ppm, and magnesium content of 0.01-20 ppm.

The concentrate flow rate of the nanofiltration device 722 is 0.01-700 L, with components of: lithium content of 50-200 ppm, potassium content of 10-20 ppm, sodium content of 0.05-150 ppm, boron content of 0.01-200 ppm, calcium content of 0.05-6000 ppm, and magnesium content of 0.01-5400 ppm.

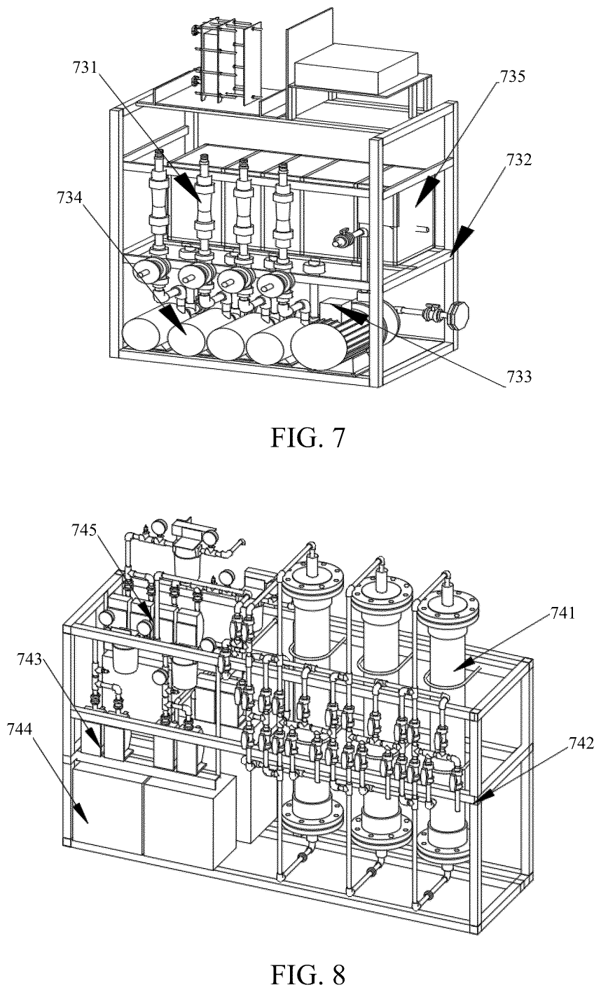

Refer to FIG. 7, the electrodialysis device 73 comprises a first support 732 and sequentially connected on the first support 732: an electrodialysis feed pump 734, a first membrane stack 731, and an electrodialysis product tank 735, and may also comprise a first direct current power supply 733.

The first membrane stack 731 consists of cathode membranes, anode membranes, and electrodes. The primary function of the first membrane stack 731 is to facilitate the migration of cations and anions to the cathode and anode chambers, respectively, under the influence of an electric field, separating salts from water and thus achieving the concentration of brine.

The first support 732 is made of materials such as carbon steel, stainless steel, or other materials capable of bearing weight, with a preference for carbon steel and stainless steel square tube materials, and more preferably stainless steel square tube materials. The first support 732 is made of stainless steel square tubes with specifications of 0-15 cm, further selecting 2-8 cm square tubes, and further selecting 5 cm square tubes. The manufacturing specifications of the first support 732 are length: 0-3 m; width: 0-1.5 m; height: 0-5 m; further manufacturing specifications are length: 1-2.5 m; width: 0.7-1.2 m; height: 1-2.5 m; and further manufacturing specifications are length: 1.5 m; width: 1 m; height: 1.4 m. The main function of the first support 732 is to support the first membrane stack 731, direct current power supply 733, electrodialysis feed pump 734, and electrodialysis product tank 735.

The first direct current power supply 733 uses lithium batteries, lead-acid batteries, sodium batteries, or solid-state batteries, preferably lithium batteries and lead-acid batteries, and more preferably lithium batteries. The main function of the first direct current power supply 733 is to provide a continuous direct current power source to the electrodes of the first membrane stack 731.

The electrodialysis feed pump 734 can be a centrifugal pump, plunger pump, or diaphragm pump, preferably centrifugal and diaphragm pumps, and more preferably centrifugal pumps. The electrodialysis feed pump 734 is made of materials such as carbon steel lined with rubber, duplex stainless steel, or non-metals, preferably duplex stainless steel and non-metals, and more preferably duplex stainless steel. The main function of the electrodialysis feed pump 734 is to transport the brine produced in the previous step to the chamber of the first membrane stack 731, thereby separating salts from water.

The electrodialysis product tank 735 is made of materials such as PE, PVC, fiberglass, organic glass, and steel, preferably PE, PVC, organic glass, and fiberglass materials, and more preferably organic glass. The electrodialysis product tank 735 is designed with 1-8 tanks, further preferred with 2-5 tanks, and further preferred with 4 tanks. The electrodialysis product tank 735 is designed as a rectangular prism with a length of 0-50 cm and a width of 0-30 cm, further preferred with a length of 20-40 cm and a width of 5-20 cm; further preferred with a length of 30 cm and a width of 15 cm. The function of the electrodialysis product tank 735 is to store concentrated brine.

The main function of the electrodialysis device 73 is to transport brine to the chamber of the electrodialysis device 75 using the electrodialysis feed pump, under the influence of a direct current electric field, cations migrate to the cathode and anions migrate to the anode, thereby achieving the concentration of brine. The brine is continuously circulated, and the salinity is gradually reduced.

The influent flow rate of the electrodialysis device 73 is 0.01-1000 L, with components of: lithium content of 800-2000 ppm, potassium content of 20-600 ppm, sodium content of 0.05-3800 ppm, boron content of 0.01-300 ppm, calcium component content of 0.001-1 ppm, and magnesium component content of 0.001-1 ppm.

The effluent (desalinated water) flow rate of the electrodialysis device 73 is 0.01-600 L, with components of: lithium content of 0.01-200 ppm, potassium content of 20-90 ppm, sodium content of 0.05-10000 ppm, boron content of 0.001-90 ppm, calcium component content of 0.001-1 ppm, and magnesium component content of 0.001-1 ppm.

The effluent (concentrated brine) flow rate of the electrodialysis device 73 is 0.01-400 L, with components of: lithium content of 15000-18000 ppm, potassium content of 140-4200 ppm, sodium content of 0.5-12000 ppm, boron content of 0.001-80 ppm, calcium component content of 0.001-1 ppm, and magnesium component content of 0.001-1 ppm.

Refer to FIG. 8, the resin deep purification device 74 comprises a second support 742 and sequentially connected on the second support 742: a resin purification feed pump 743, a resin column 741, and a resin product tank 744, as well as instruments 745.

The resin column 741 is made of PVC, UPVC, and CPVC, preferably PVC. The manufacturing dimensions of the resin column 741 are a diameter of 0.1-1.5 m and a height of 0.5-3 m, further preferred with a diameter of 0.2-1 m and a height of 1-2 m; further preferred with a diameter of 0.5 m and a height of 1.8 m. The main function of the resin column 741 is to hold the resin, where adsorption and elution of calcium, magnesium, and boron ions occur, removing calcium and magnesium from the lithium concentrate to meet the required specifications.

The second support 742 is made of materials such as carbon steel, stainless steel, or other square tube materials capable of bearing weight. It is preferred to make the second support 742 with carbon steel and stainless steel square tube materials, preferably stainless steel square tube materials. The second support 742 is made of stainless steel square tubes with specifications of 0-15 cm, further selecting 2-8 cm square tubes, and further selecting 5 cm square tubes. The manufacturing specifications of the second support 742 are length: 0-3 m; width: 1-2 m; height: 0-5 m; further manufacturing specifications are length: 1-2.5 m; width: 0.7-1.2 m; height: 1-2.5 m; and further manufacturing specifications are length: 2 m; width: 1 m; height: 1.8 m. The main function of the second support 742 is to support the resin column 741, second support 742, resin purification feed pump 743, resin product tank 744, and instruments 745, etc.

The resin purification feed pump 743 can be a centrifugal pump, plunger pump, or diaphragm pump, preferably centrifugal and diaphragm pumps, and more preferably centrifugal pumps. The resin purification feed pump 743 is made of materials such as carbon steel, duplex stainless steel, or non-metals, preferably duplex stainless steel and non-metals, and more preferably duplex stainless steel. The main function of the resin purification feed pump 743 is to transport concentrated brine, elution liquid, regeneration liquid, and pure water.

The resin product tank 744 is made of materials such as PE, PVC, fiberglass, organic glass, and steel, preferably PE, PVC, organic glass, and fiberglass materials, and more preferably organic glass. The resin product tank 744 is designed with 1-8 tanks, further preferred with 2-5 tanks, and further preferred with 2 tanks. The resin product tank 744 is designed as a cylindrical shape with a diameter of 0-50 cm and a height of 0.1-2.5 m, further preferred with a diameter of 10-30 cm and a height of 0.1-1.5 m; further preferred with a diameter of 30 cm and a height of 1.2 m. The main function of the resin product tank 744 is to store the concentrate liquid from which calcium, magnesium, and boron have been removed.

The main function of the resin deep purification device 74 is to remove calcium, magnesium, and boron from the lithium concentrate, ensuring that the lithium concentrate meets the impurity content specifications required for lithium salt products.

The influent flow rate of the resin deep purification device 74 is 0.01-1000 L, with components of: lithium content of 800-2000 ppm, potassium content of 20-600 ppm, sodium content of 0.05-3800 ppm, boron content of 0.01-300 ppm, calcium content of 0.05-20 ppm, and magnesium content of 0.01-20 ppm.

The effluent flow rate of the resin deep purification device 74 is 0.01-1000 L, with components of: lithium content of 800-2000 ppm, potassium content of 20-600 ppm, sodium content of 0.05-3800 ppm, boron content of 0.01-20 ppm, calcium content of 0.001-1 ppm, and magnesium content of 0.001-1 ppm.

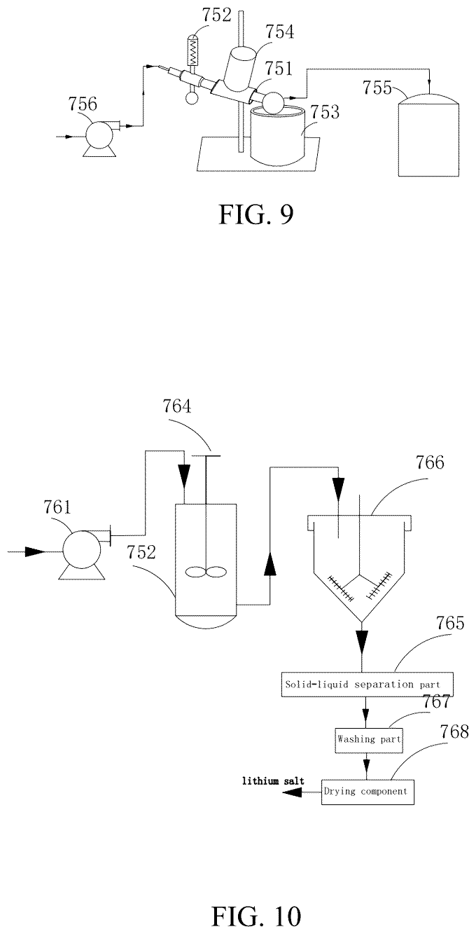

Refer to FIG. 9, the evaporation device 75 comprises an evaporation container 751, a cooling component 752, a heating component 753, a second drive component 754, an evaporation product tank 755, and an evaporation feed pump 756.

The evaporation container 751 is made of organic glass or transparent PVC, preferably organic glass. The evaporation container 751 has a diameter of 0-50 cm, and is further preferred to be 30 cm in diameter. The evaporation container 751 is primarily used for holding lithium-containing solutions and ensuring even heating.

The cooling component 752 is made of organic glass or transparent PVC, preferably organic glass. The cooling component 752 has a diameter of 0-30 cm, and is further preferred to be 20 cm in diameter. The cooling component 752 is primarily used for cooling the water in the evaporated lithium solution, ensuring the pressure within the cooling component 752.

The heating component 753 is made of carbon steel or stainless steel, preferably stainless steel, and is designed with a coil heating facility. The heating component 753 has a diameter of 0-80 cm, and is further preferred to be 60 cm in diameter. The heating component 753 is primarily used for heating the evaporation container 751.

The second drive component 754 is motor-driven. The second drive component 754 mainly drives the rotation of the heating component 753, ensuring even heating of the lithium solution within the heating component 753.

The evaporation feed pump 756 functions to pump the lithium-containing solution from the resin product tank into the evaporation container 751.

The primary function of the evaporation device 75 is to concentrate lithium-containing solutions, enabling the lithium concentration in the solution to reach the levels required for lithium precipitation.

Refer to FIG. 10, the lithium precipitation device 76 comprises sequentially connected components: a lithium precipitation feed pump 761, a lithium precipitation reactor 762, a thickener (thickening device) 764, a solid-liquid separation unit 765, a washing unit 766, and a drying unit 767; the lithium precipitation reactor 762 is equipped with a stirring component 763.

The lithium precipitation reactor 762 is made of organic glass with a diameter of 60 cm and a height of 90 cm, primarily used for holding generated lithium carbonate, lithium phosphate, and other substances, while also receiving heat from the heating component.

The stirring component 763 is made of carbon steel, stainless steel, or non-metallic materials (PTFE, CPVC, PVC, etc.), preferably non-metallic materials (PTFE). The stirring component 763 is a paddle-type impeller with a diameter of 40 cm and a height of 80 cm. The function of the stirring component 763 is to ensure thorough reaction of substances such as lithium carbonate and lithium phosphate, resulting in larger particle size of precipitated lithium salts.

The solid-liquid separation unit 765 is made of carbon steel, duplex stainless steel, or non-metallic materials, preferably duplex stainless steel. The solid-liquid separation unit 765 is a plate centrifuge with a diameter of 50 cm and a height of 40 cm. The function of the solid-liquid separation unit 765 is to separate the lithium salt suspension into solids and liquids, obtaining lithium salt products.

The function of the lithium precipitation device 76 is to introduce lithium-rich brine into the lithium precipitation reactor, maintain a certain reaction temperature, and gradually add sodium carbonate/phosphate to react and form lithium salt products. Through centrifugal separation, lithium salt products such as lithium carbonate, lithium hydroxide, lithium chloride, or lithium phosphate that meet the requirements are obtained.

The lithium precipitation device 76 is preferably used to prepare lithium carbonate, with the reaction mechanism: Na₂CO₃+2LiCl→Li₂CO₃+2NaCl.

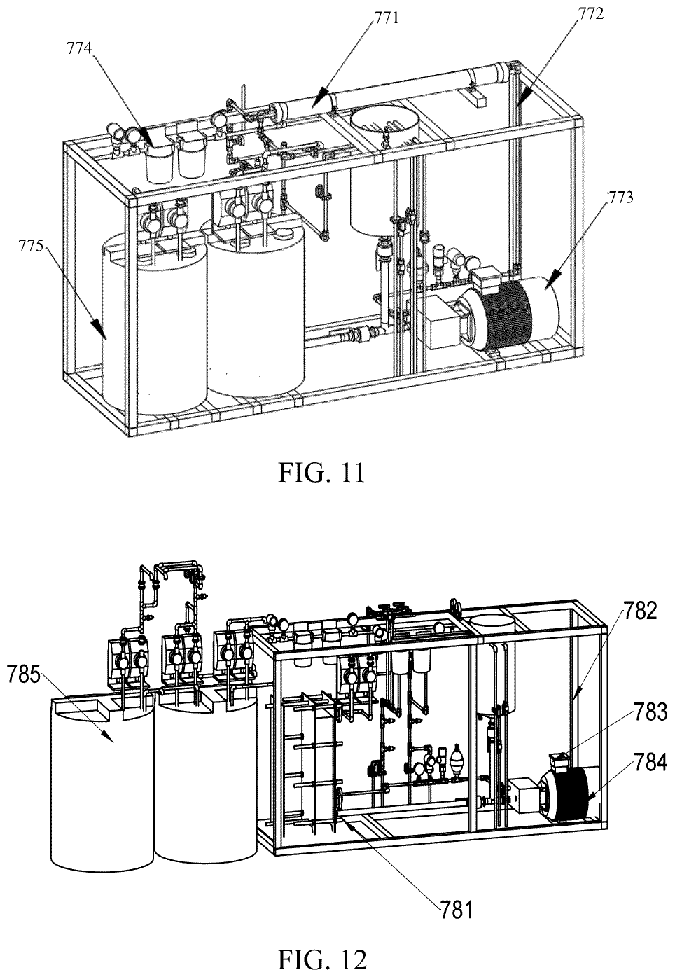

Refer to FIG. 11, the pure water preparation device 77 consists of a third membrane tube 771, a third membrane support 772, a first pump 773, a third control valve 774, and a first water tank 775.

The third membrane tube 771 is made of materials such as fiberglass, stainless steel, or ceramic, preferably fiberglass and stainless steel, and more preferably fiberglass. The function of the third membrane tube 771 is to fill the membrane and prepare pure water. The manufacturing dimensions of the third membrane tube 771 are 1 cm-30 cm in diameter, further preferred 5 cm-20 cm, and further preferred 10 cm.

The third membrane support 772 is made of materials such as carbon steel, stainless steel, or other square tube materials capable of bearing weight. It is preferred to make the third membrane support 772 with carbon steel and stainless steel square tube materials, preferably stainless steel square tube materials. The third membrane support 772 is made of stainless steel square tubes with specifications of 0-10 cm, further selecting 2-8 cm square tubes, and further selecting 5 cm square tubes. The manufacturing specifications of the third membrane support 772 are length: 0-3 m; width: 0-1.5 m; height: 0-5 m; further manufacturing specifications are length: 1-2.5 m; width: 0.7-1.2 m; height: 1-2.5 m; and further manufacturing specifications are length: 2 m; width: 1 m; height: 1.3 m.

The main function of the third membrane support 772 is to support the third membrane tube 771, first pump 773, third control valve 774, and first water tank 775, etc., and is fixed on the base frame 2 at the bottom of the movable box 1.

The first pump 773 can be a centrifugal pump, plunger pump, or diaphragm pump, preferably centrifugal and diaphragm pumps, and more preferably centrifugal pumps. The first pump 773 is made of materials such as carbon steel, duplex stainless steel, or non-metals, preferably duplex stainless steel and non-metals, and more preferably duplex stainless steel. The main function of the first pump 773 is to transport water and increase pressure.

The third control valve 774 is made of materials such as carbon steel, duplex stainless steel, UPVC, CPVC, or PVC, preferably duplex stainless steel, UPVC, CPVC, or PVC, and more preferably PVC. The function of the third control valve 774 is to control the opening and closing of the control valve through the control system, thereby achieving the on-off and flow direction of the material.

The first water tank 775 is made of materials such as PE, PVC, fiberglass, and steel, preferably PE, PVC, and fiberglass materials, and more preferably PE material. The first water tank 775 is designed with 1-5 tanks, further preferred with 1-3 tanks, and further preferred with 2 tanks. The first water tank 775 is designed with a diameter of 0-1.5 m, further preferred with 0.1-0.8 m, and further preferred with 0.6 m. The function of the first water tank 775 is to store tap water and pure water.

The function of the pure water preparation device 77 is to use a seawater desalination membrane, through the first pump 773 and the third control valve 774 to transport tap water to the membrane, achieving the preparation of pure water, which is stored in the freshwater tank for use in the entire process of extracting lithium salts, with high-hardness water being directly discharged. Refer to FIG. 12, the acid-base preparation device 78 consists of a second membrane stack 781, a third support 782, a second direct current power supply 783, a second pump 784, and a second water tank 785.

The second membrane stack 781 is composed of cathode membranes, bipolar membranes, anode membranes, and electrodes. The primary function of the second membrane stack 781 is to ionize pure water on the bipolar membrane under the influence of an electric field, forming hydrogen ions and hydroxide ions, with cations and anions migrating to the cathode and anode chambers, respectively, to form acid and base, thus achieving the preparation of acid and base.

The third support 782 is made of materials such as carbon steel, stainless steel, or other materials capable of bearing weight. It is preferred to make the third support 782 with carbon steel and stainless steel square tube materials, preferably stainless steel square tube materials. The third support 782 is made of stainless steel square tubes with specifications of 0-15 cm, further selected for 2-8 cm square tube fabrication, and more preferably, 5 cm square tubes. The manufacturing specifications for the third support 782 are as follows: length: 0-3 m; width: 0-1.5 m; height: 0-5 m. Further specifications comprise: length: 1-2.5 m; width: 0.7-1.2 m; height: 1-2.5 m. More specifically, the dimensions are: length: 1.5 m; width: 1 m; height: 1.4 m. The primary function of the third support 782 is to support components such as the second membrane stack 781, second direct current power supply 783, second pump 784, and second water tank 785.

The second direct current power supply 783 utilizes lithium batteries, lead-acid batteries, sodium batteries, or solid-state batteries, with a preference for lithium and lead-acid batteries, and a more specific preference for lithium batteries. The main function of the second direct current power supply 783 is to provide a continuous direct current power source to the electrodes of the second membrane stack 781.

The second pump 784 can be a centrifugal pump, plunger pump, or diaphragm pump, preferably centrifugal and diaphragm pumps, and a more specific preference for centrifugal pumps. The second pump 784 is made of materials such as carbon steel, duplex stainless steel, or non-metals, preferably duplex stainless steel and non-metals, and a more specific preference for duplex stainless steel. The main function of the second pump 784 is to transport concentrated brine to the electrodialysis chamber, thereby separating salt from water.

The second water tank 785 is made of materials such as PE, PVC, fiberglass, organic glass, and steel. It is preferred to make it with PE, PVC, organic glass, and fiberglass materials, with a more specific preference for organic glass materials. The second water tank 785 is designed with 1-8 tanks, further preferred with 2-5 tanks, and more specifically preferred with 4 tanks. The second water tank 785 is designed as a rectangular prism with a length of 0-50 cm and a width of 0-30 cm, further preferred with a length of 20-40 cm and a width of 5-20 cm; more specifically, the dimensions are 30 cm in length and 15 cm in width. The function of the second water tank 785 is to store desalinated water, concentrated brine, catholyte, and anolyte.

The primary function of the acid-base preparation device 78 is to pump concentrated brine and pure water into the chamber of the acid-base preparation device 78, where, under the influence of a direct current electric field, water is ionized and cations migrate to the cathode while anions migrate to the anode, forming acid and base, thus achieving the preparation process of hydrochloric acid and sodium hydroxide for resin regeneration.

The control system 79 consists of an electrical control system 791 and an automatic control system 792. The electrical control system 791 mainly uses electrical components to achieve power supply and control of moving equipment. The automatic control system 792 mainly uses PLC to achieve the start and stop of pumps, temperature control valves, and pressure control valves. The control process of the control system 79 is known from existing technology and is not improved upon in this disclosure.

### Example 2: Process for Extracting Lithium Salts from Brine of Brine Lakes

This example used the movable laboratory from Example 1 to specifically implement the process of extracting lithium salts from brine of brine lakes as follows: the brine was subjected to adsorption separation using the adsorption separation device 71, where the adsorbent's selective affinity for lithium allows for the adsorption of lithium onto the adsorbent. After washing and elution processes, a lithium-containing qualified liquid with low levels of other impurities was obtained. This qualified liquid was then fed into the membrane device 72 for concentration and purification, yielding a liquid produced from membrane. This product liquid was further processed in the electrodialysis device 73 for separation, purification, and concentration, resulting in a liquid produced from electrodialysis. The liquid produced from electrodialysis was then introduced into the resin deep purification device 74, where calcium, magnesium, and boron elements were removed through resin adsorption, reducing the levels of calcium and magnesium to less than 10 ppm and boron to less than 20 ppm, yielding a liquid produced from resin. The liquid produced from resin was then fed into the evaporation device 75 for concentration through evaporation, yielding a concentrated solution. This concentrated solution was then introduced into the lithium precipitation device 76, where a lithium precipitation reaction occurs, resulting in lithium salts. The entire process was fully automated and recorded to ensure the accuracy and completeness of the experimental results.

Specifically:

1) Raw brine was pumped into the adsorption separation device 71 via the feed pump 7113 for adsorption separation. The elution water temperature was controlled at 35° C. After the adsorption separation, the qualified liquid was transported to the qualified liquid tank 712 and then fed into the reverse osmosis device 721 via the RO membrane feed pump 7213.

2) The qualified liquid undergoes concentration and purification in the reverse osmosis device 721, and the resulting concentrated liquid was sent to the nanofiltration device 722 for further separation and purification. The qualified liquid was first transported by the RO membrane feed pump 7213 to the reverse osmosis device 721 for treatment. After treatment by the RO reverse osmosis membrane, the permeate side water could be recycled, and the concentrate side water entered the RO membrane product tank 7215. It was then transported to the nanofiltration device 722 via the NF membrane feed pump 7223 for treatment. The permeate side water after nanofiltration membrane treatment was sent to the NF membrane product tank 7225 and then to the electrodialysis device 73. The liquid was transported by the electrodialysis feed pump 734 to the first membrane stack 731 for continued separation, purification, and concentration. After treatment by the first membrane stack 731, the product liquid was sent to the electrodialysis product tank 735. After further concentration treatment by electrodialysis, the lithium concentration in the rich lithium solution could reach approximately 15-18 g/L. The solution was then transported by the resin purification feed pump 743 to the resin deep purification device 74 for fine removal of calcium, magnesium, and boron elements. The product liquid entered the resin product tank 744, reducing calcium and magnesium in the rich lithium solution to less than 10 ppm; the boron content was less than 20 ppm. After continuous treatment by the electrodialysis device 73 and the resin deep purification device 74, the lithium concentration in the rich lithium solution could reach 17-20 g/L.

3) The product liquid was first transported from the resin product tank 744 by the evaporation feed pump 756 to the evaporation device 75 for further treatment. The evaporation device 75 was set to operate at a temperature of 100° C. After evaporation separation and purification, the lithium concentration in the product liquid was increased, and the impurity content in the rich lithium solution was greatly reduced. The rich lithium solution was then transported to the evaporation product tank 755, where the concentrated solution could reach a lithium concentration of 20-25 g/L, making it suitable for lithium precipitation reaction.

4) The concentrated lithium solution after evaporation purification was then sent to the lithium precipitation device 76, where it was transported by the lithium precipitation feed pump 761 to the lithium precipitation reactor 762. Sodium carbonate was added, and the mixture was heated to approximately 80° C. After stirring and reaction, the crystalline slurry was fed into the thickener 764 for further thickening treatment. The filter cake obtained after separation by the solid-liquid separation unit 765 was further washed by the washing unit 766 to remove impurities, and then dried by the drying unit 767 to obtain lithium salts. The main content of lithium salts in the product can reach 88-99.4%, wherein the main content of lithium salts refers to the content of lithium carbonate and lithium chloride.

Preferably, the process also comprises a resin regeneration step:

5) Resin regeneration: the concentrated brine and pure water were pumped into the chamber of the acid-base preparation device 78, where, under the influence of a direct current electric field, water was ionized, and cations migrated to the cathode while anions migrated to the anode, achieving the in situ preparation of hydrochloric acid and sodium hydroxide, which were then used for resin regeneration.

The movable device or movable laboratory of the present disclosure all adopt a modular assembly structure, which allows for flexible assembly and disassembly of multiple devices according to different experimental objectives, material properties, and testing requirements. Water, electricity, and other materials are connected to the movable box from quick connectors set on the box. The interfaces of each device use quick connectors to meet the requirements for rapid on-site assembly and disassembly, capable of meeting the experimental requirements of a pilot scale, greatly shortening the experimental cycle.

Moreover, the movable device or movable laboratory of the present disclosure avoids the limitations of needing to transport intermediate solutions to fixed laboratories or workshops at a considerable distance by conducting in situ experimental processes in brine lake mining areas. It also avoids the limitations of needing to provide additional acids or bases for experiments in areas with difficult acid-base transportation, especially in areas lacking acid and base.

In summary, the movable device or movable laboratory of the present disclosure for extracting lithium salts from brine of brine lakes is simple to operate, flexible in experimental site, requires less input from experimental personnel, and can simulate the entire experimental process from adsorption-membrane coupling to lithium precipitation reaction, greatly improving experimental efficiency. The entire set of experimental devices, after modular assembly, can be flexibly transported to the brine lake site for in situ simulation experiments and in situ preparation of acids or bases required for the process, achieving the simulation of the entire production process from brine lake brine to lithium salts. This significantly improves the efficiency of resource development, realizes the high efficiency of resource comprehensive utilization, and generates good economic benefits.

1. A movable laboratory, comprising: a movable box (1) and a brine purification device and a lithium precipitation device (76) set inside the movable box (1); wherein the brine purification device is connected to the lithium precipitation device (76); the brine purification device comprises one or more of an adsorption separation device (71), a membrane device (72), an electrodialysis device (73), a resin deep purification device (74), and an evaporation device (75);
preferably, the adsorption separation device (71) contacts the lithium-containing solution with a lithium adsorbent (preferably an adsorbent produced under patent No. ZL202011080243.2) filled in a rotating device, and adsorbs lithium from the lithium-containing raw material onto the adsorbent through the selectivity of the adsorbent for lithium;
preferably, the size of the adsorption separation device (71) can be determined based on the amount of adsorbent resin filled (i.e., the volume of the adsorbent) V_{ads}, where V_{ads} is calculated as follows:
V_{ads}=Qₗᵢₜₕᵢᵤₘ/(η_{yield}*C_{adsorption}), where:
V_{ads} - - - Volume of adsorbent (L)
Qₗᵢₜₕᵢᵤₘ - - - Amount of lithium metal produced (g)
C_{adsorption} - - - Adsorption capacity of the adsorbent (g/L)
η_{yield} - - - Lithium yield
preferably, C_{adsorption} represents the adsorption capacity (g/L) of the adsorbent in patent number ZL202011080243.2;
preferably, the movable laboratory is equipped with an exhaust facility for air circulation between the interior space of the movable box (1) and the outside, maintaining a constant temperature to ensure the safety of operating personnel;
preferably, a lighting facility is set for illumination, so as to meet 24-hour operation per day and improve experimental efficiency;
preferably, the movable laboratory is used to simulate laboratory lithium salt process technology development and verification work at a non-laboratory site.

2. The movable laboratory according to claim 1, wherein the brine purification device comprises an adsorption separation device (71), a membrane device (72), an electrodialysis device (73), a resin deep purification device (74), and an evaporation device (75) connected in sequence; and the evaporation device (75) is connected to the lithium precipitation device (76).

3. The movable laboratory according to claim 2, wherein several said movable boxes are set, among which a movable box is equipped with one or more of an adsorption separation device (71), a membrane device (72), an electrodialysis device (73), a resin deep purification device (74), an evaporation device (75), and a lithium precipitation device (76).

4. The movable laboratory according to claim 2, wherein the adsorption separation device (71), membrane device (72), electrodialysis device (73), resin deep purification device (74), evaporation device (75), and lithium precipitation device (76) are connected in sequence using quick connectors.

5. The movable laboratory according to claim 1, wherein the movable laboratory comprises an acid-base preparation device (78) set inside the movable box (1); and/or,
the movable laboratory comprises a pure water preparation device (77) set inside the movable box (1);
preferably, the movable box (1) has a base frame (2) fixedly installed on both sides; the brine purification device and lithium precipitation device (76) are set on the base frame (2).

6. The movable laboratory according to claim 1, wherein an exhaust facility (5) is set on the movable box (1); and/or,
a lighting facility (6) is set inside the movable box (1).

7. The movable laboratory according to claim 1, wherein the membrane device (72) comprises an ultrafiltration device (721) and a nanofiltration device (722) connected in sequence.

8. The movable laboratory according to claim 1, wherein the ultrafiltration device (721) comprises a first membrane rack (7212) and an RO membrane feed pump (7213), a first membrane tube (7211), and an RO membrane product tank (7215) connected in sequence set on the first membrane rack (7212); and/or,
the nanofiltration device (722) comprises a second membrane rack (7222) and an NF membrane feed pump (7223), a second membrane tube (7221), and an NF membrane product tank (7225) connected in sequence set on the second membrane rack (7222).

9. The movable laboratory according to claim 1, wherein the electrodialysis device (73) comprises a first rack (732) and an electrodialysis feed pump (734), a first membrane stack (731), and an electrodialysis product tank (735) connected in sequence set on the first rack (732); and/or,
the resin deep purification device (74) comprises a second rack (742) and a resin purification feed pump (743), a resin column (741), and a resin product tank (744) connected in sequence set on the second rack (742); and/or,
the lithium precipitation device (76) comprises a lithium precipitation feed pump (761), a lithium precipitation reactor (762), a thickener (764), a solid-liquid separation unit (765), a washing unit (766), and a drying unit (767) connected in sequence; and a stirring unit (763) is set inside the lithium precipitation reactor (762);
after adsorbing lithium from the lithium-containing raw material onto the adsorbent, then desorbing to obtain a lithium-containing qualified liquid with less impurities, which is sent to the membrane device (72) for further treatment via pipelines or conveying equipment;
the main function of the electrodialysis device (73) is to send diluted brine to the chamber of the electrodialysis device (75) by the electrodialysis feed pump, under the action of a direct current electric field, cations migrate to the cathode, and anions migrate to the anode, thereby achieving the process of diluting brine concentration, and the brine is continuously circulated, and the salinity is gradually reduced;
the main function of the resin deep purification device (74) is to remove calcium, magnesium, and boron from the lithium-containing concentrated solution, so that the lithium-containing concentrated solution meets the impurity content requirements of lithium salt product specifications;
the main function of the evaporation device (75) is to concentrate the lithium-containing solution, so that the lithium in the solution can reach the concentration required for lithium precipitation;
the function of the lithium precipitation device (76) is to send the lithium-rich brine into the lithium precipitation reactor, maintain a certain reaction temperature, and gradually add sodium carbonate/sodium phosphate for the reaction, to produce lithium salt products, and obtain lithium salt products such as lithium carbonate, lithium hydroxide, lithium chloride, or lithium phosphate that meet the requirements through centrifugal separation;
the function of the pure water preparation device (77) is to use seawater desalination membranes, through the first pump (773), the third control valve (774) combination to transport tap water into the membrane, to achieve the preparation of pure water, pure water is stored in a fresh water tank for the entire process of extracting lithium salts, and water with high hardness is directly discharged;
the main function of the acid-base preparation device (78) is to transport concentrated brine and pure water to the chamber of the acid-base preparation device (78) by the pump, under the action of a direct current electric field, water is ionized, cations migrate to the cathode, and anions migrate to the anode, thereby achieving the preparation process of a acid and a base, specifically preparing hydrochloric acid and sodium hydroxide, for resin regeneration.

10. A method for simulating the entire lithium salt process experiment at a non-laboratory site, wherein the method comprises simulating the entire lithium salt process experiment in the movable laboratory according to claim 1;
preferably, in the method:
brine lake brine is adsorbed and separated by the adsorption separation device (71), lithium is adsorbed onto the adsorbent through the selective characteristics of the adsorbent for lithium, and after washing and desorbing processes, a lithium-containing qualified liquid with low impurity content is obtained;
the lithium-containing qualified liquid enters the membrane device (72) for concentration and purification to obtain a liquid produced from membrane;
the liquid produced from membrane then enters the electrodialysis device (73) for separation, purification, and concentration to obtain a liquid produced from electrodialysis;
the liquid produced from electrodialysis enters the resin deep purification device (74), and calcium, magnesium, and boron elements are removed by resin adsorption, reducing the calcium and magnesium in the solution to less than 10 ppm, and the boron content to less than 20 ppm, to obtain a liquid produced from resin;
The liquid produced from resin enters the evaporation unit (75) for concentration by evaporation, yielding a concentrated brine; the concentrated brine then proceeds to the lithium precipitation unit (76) for lithium precipitation reaction, to yield a lithium salt;
the entire process is under full-automatic control and documentation to ensure the precision and integrity of the experimental outcomes;
preferably, the movable laboratory is equipped with an exhaust system for air exchange between the interior space of the movable box (1) and the external environment, so as to maintain a constant temperature and ensure the safety of operating personnel;
preferably, a lighting facility is installed for illumination, accommodating round-the-clock operations and enhancing the efficiency of the experimental procedures.
